(19) United States
(12) Patent Application Publication
(10) Pub. No.: US 2025/0322460 A1
(43) Pub. Date: Oct. 16, 2025

(54) INTEGRATED SYSTEM FOR CONTEXT AWARE FINANCIAL MANAGEMENT

(71) Applicant: Bernt Erik Bjontegard, San Diego, CA (US)

(72) Inventor: Bernt Erik Bjontegard, San Diego, CA (US)

(21) Appl. No.: 18/991,423

(22) Filed: Dec. 21, 2024

Related U.S. Application Data
(60) Provisional application No. 63/613,775, filed on Dec. 22, 2023.

(51) Int. Cl. G06Q 40/06

(52) U.S. Cl. CPC G06Q 40/06

(57) ABSTRACT

A system for managing financial portfolio as well as for recommending personalized investment strategies, is disclosed. The system includes a first computing unit having an application interface, communicably connected to a central controller. The central controller includes a back-end server. The backend server includes a data receiving component adapted to receive the input data-sets from the first computing unit and real time data-sets from a plurality of data-sources. The backend server further includes a data analysis module adapted to process the real-time data to generate one or more actionable insights. The backend server furthermore includes a contextually intelligent portfolio management module adapted to utilize one or more contextual data related to the user, to monitors the user's investments and asset portfolios, and generate contextually relevant portfolio information for the user in a real-time. The backend server additionally includes a financial strategy implementation module adapted to utilize the actionable insights in combination with the contextually relevant portfolio information of the user to generate personalized investment strategies and recommendations for each user. In operation, a user generates and/or formulate at least one input query based at least in part on one or more input data-sets related to the user's financial portfolio. Thereafter, the input datasets are received at the back-end server which in turn are processed by the financial strategy implementation module in combination with one or more actionable insights generated by the data analysis module of the back-end server to identify a response to the input query, and/or provide one or more personalized investment related recommendation. The identified information and/or recommendation is elicited as a response to the input query and is presented and/or visualized on an output component of the first computing unit.

### FIELD OF THE INVENTION

The present invention relates to the field of data management, more specifically to an integrated system of context aware financial management and collaboration ecosystem.

### BACKGROUND

Managing investments and financial portfolios has historically been a complex and resource-intensive process. Investors face a multitude of challenges, such as staying updated with rapidly changing market conditions, interpreting vast amounts of data from diverse sources, and aligning investment decisions with their individual financial goals. Financial data flows in from numerous channels, including stock exchanges, market indices, economic reports, financial news platforms, and expert analyses. This creates a fragmented data environment, where consolidating and deriving meaningful insights becomes a daunting task. Moreover, interpreting such data requires expertise, as well as tools capable of identifying trends, predicting risks, and evaluating potential opportunities.

Additionally, the diversity among investors further complicates the process. Each investor has unique financial objectives, risk tolerances, and preferences. While some may prioritize high-risk, high-reward strategies, others may focus on steady, long-term growth. Traditional tools often fail to offer the level of customization required to cater to these varied needs, leaving many investors dependent on manual efforts or generalized advice that may not align with their specific goals. This gap is particularly critical in dynamic financial markets, where opportunities can emerge and vanish within moments, and risks can escalate unexpectedly. Without access to advanced, real-time analytical tools and personalized guidance, investors may miss lucrative opportunities or make suboptimal decisions, potentially leading to financial losses.

The growing complexity of investment management underscores the urgent need for innovative solutions that simplify the process while offering robust, data-driven insights. Such solutions should seamlessly integrate real-time data analysis, personalized strategies, and user-friendly interfaces to empower investors across all levels of expertise. This need forms the backdrop against which advancements in financial technology and AI-driven tools have begun to emerge, aiming to bridge these gaps and enable smarter, more effective portfolio management.

### SUMMARY

In view of the foregoing, an embodiment herein provides a context aware system for managing financial portfolio as well as for recommending personalized investment strategies. The system includes a first computing unit communicably connected to a central controller via a communication medium. The first computing unit comprises one or more input means, one or more output components and application having an application interface connected to the central controller.

The central controller includes a back-end server adapted to receive an input data-sets from the first computing unit. Further, the backend server includes a data receiving component adapted to receive the input data-sets from the first computing unit. The input data-set may include but is not limited to one or more input query related to financial management of the user and/or contextual data relevant to user's financial portfolio. Further, the data receiving component is adapted to receive real time data-sets from a plurality of data-sources. The real time data includes but is not limited to monitoring market changes, asset performance, and financial events. The backend server further includes a data analysis module adapted to process the real-time data to generate one or more actionable insights by leveraging machine learning techniques to identify trends and predict potential market shifts. The backend server furthermore includes a contextually intelligent portfolio management module adapted to utilize one or more contextual data related to the user, to monitors the user's investments and asset portfolios, and generate contextually relevant portfolio information for the user in a real-time. The backend server additionally includes a financial strategy implementation module adapted to utilize the actionable insights in combination with the contextually relevant portfolio information of the user to generate personalized investment strategies and recommendations for each user.

In operation, a user generates and/or formulate at least one input query based at least in part on one or more input data-sets related to the user's financial portfolio. Thereafter, the input datasets are received at the back-end server which in turn are processed by the financial strategy implementation module in combination with one or more actionable insights generated by the data analysis module of the back end server using one or more programming instructions, thereby causing a processing unit of the back-end server to identify a response to the input query, and/or provide one or more personalized service including but not limited to managing, monitoring, and recommending or visualizing financial implementation strategies onto the application interface, which displays user-specific portfolio analytics, market updates, and actionable alerts. The identified information is elicited as a response to the input query and is presented and/or visualized on the output component of the first computing unit. Users are empowered to independently access their personalized investment strategies while ensuring that data segregation and security protocols are strictly followed to protect sensitive financial information. This integrated approach provides a robust and secure platform for dynamic portfolio management and personalized financial guidance. Accordingly, it may be understood that the system of the current disclosure utilizes contextual information of a user in combination of various real time market dynamics, to provide a personalized management & recommendation strategy to the users.

In another aspect of the present invention, a method for managing and recommending personalized investment strategies is disclosed. The method includes accessing and interacting with user data, including profile information, investment history, preferences, and real-time input data such as market, stock, and financial data. A computing unit with an application interface establishes a communicable connection with a backend server, enabling the continuous reception of real-time input from diverse sources. The backend server normalizes and processes this data to generate actionable insights using advanced analytics and machine learning algorithms. It continuously monitors user investments and portfolios, generating contextually relevant portfolio information in real-time. These insights and portfolio data are combined to create personalized investment strategies tailored to the user's goals and preferences. The system automatically manages, monitors, and visualizes these strategies on the application interface, empowering users with real-time analytics, actionable alerts, and secure access to optimized financial recommendations.

In an aspect, the financial strategy implementation module utilizes machine learning algorithms for continuously improving the quality of actionable insights and recommendations.

In yet another aspect, the users are allowed to independently access personalized investment strategies while ensuring data segregation and security.

Advantageously, the application interface of the computing unit displays user-specific portfolio analytics, market updates, and actionable alerts.

### BRIEF DESCRIPTION OF THE ACCOMPANYING DRAWINGS

The above-mentioned implementations are further described herein regarding the accompanying figures. It should be noted that the description and figures relate to exemplary implementations and should not be construed as a limitation to the present disclosure. It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

FIG. 1 depicts an exemplary financial asset management and recommendation system, in accordance to an embodiment of the current disclosure;

FIG. 2 depicts an exemplary embodiment showing the interconnection of a data exchange platform withing the financial asset management and recommendation system of the current disclosure;

FIG. 3 depicts user data used for the generation of personalized recommendation strategies, in accordance to an embodiment of the current disclosure;

FIG. 4 depicts real-time input data provided to the data receiving component through the computing unit, in accordance to an embodiment of the current disclosure;

FIG. 5 depicts a plurality of data-sources from where the real-time input data is received, in accordance to an embodiment of the current disclosure;

FIG. 6 depicts various sub-modules of the data analysis module, in accordance to an embodiment of the current disclosure;

FIG. 7 depicts various sub-modules of the contextually intelligent portfolio management module, in accordance to an embodiment of the current disclosure;

FIG. 8 depicts various sub-modules of the financial strategy implementation module, in accordance to an embodiment of the current disclosure;

FIG. 9 depicts various sub-modules of the data exchange platform, in accordance to an embodiment of the current disclosure;

FIG. 10 depicts the workflow of the investment strategies management and recommendation system, in accordance to an embodiment of the current disclosure;

FIG. 11 depicts an exemplary financial asset management and recommendation process for users, in accordance to an embodiment of the current disclosure; and

FIG. 12 depicts an exemplary implementation of the financial asset management and recommendation process for users, in accordance to an embodiment of the current disclosure.

### DETAILED DESCRIPTION

Embodiments, of the present disclosure, will now be described with reference to the accompanying drawing.

In the following description, certain specific details are outlined to provide a thorough understanding of various disclosed embodiments. However, one skilled in the relevant art will recognize that embodiments may be practiced without one or more of these specific details, or with other methods, components, materials, etc.

Unless the context indicates otherwise, throughout the specification and claims which follow, the word “comprises” and variations thereof, such as, “comprises” and “comprising” are to be construed in an open, inclusive sense that is as “including, but not limited to.” Further, the terms “first,” “second,” and similar indicators of the sequence are to be construed as interchangeable unless the context clearly dictates otherwise.

Embodiments of the invention are directed to methods, computerized systems, and computer-readable media for use in managing of financial portfolio as well for recommending personalized investment strategies, without limiting to any particular financial segment. In a preferred embodiment, the present application discloses utilizing a computing unit preferably in the form of a communication device, dynamically, and in a real time. Particularly, the computing unit includes an application interface adapted to generate one or more queries, on the basis of user's input including input data-sets in the form of text, images, model number, photographs, and the like, which is shared with a back-end server of a central controller. The input data-sets include user data, including user profiles, investment history, behavioral data, preferences, and real-time input data. Thereafter, on the basis of identified financial strategy, classified information type, requested information is retrieved and shared with the first computing unit. The system is further adapted to automatically send push notifications such that the information thus retrieved related to the product can be visualized in a real time. The application interface is generally provided in the form of a GUI application that could be installed on a communication device, preferably in the form of a mobile application. However, in another embodiments, the system may be in form of a web-based automated service accessible on a generally known computing unit.

It includes a data receiving component designed to gather real-time data from diverse sources, continuously monitoring market changes, asset performance, and financial events.

The data is then normalized and processed by a data analysis module, which generates actionable insights by leveraging machine learning techniques to identify trends and predict potential market shifts. These insights are fed into a contextually intelligent portfolio management module, which monitors the user's investments and asset portfolios, ensuring that portfolio information is updated in real-time. The financial strategy implementation module uses these insights and portfolio information to generate personalized investment strategies and recommendations for each user. The central controller is responsible automatically managing, monitoring, and recommending or visualizing these strategies directly onto the application interface, which displays user-specific portfolio analytics, market updates, and actionable alerts. Users art empowered to independently access their personalized investment strategies while ensuring that data segregation and security protocols are strictly followed to protect sensitive financial information. This integrated approach provides a robust and secure platform for dynamic portfolio management and personalized financial guidance.

The investment strategies management and recommendation system offers several significant advantages, primarily by providing a highly personalized and automated approach to investment management. It enables users to receive personalized investment strategies based on real-time market data, asset performance, and individual preferences. By integrating machine learning and AI-driven analysis, the investment strategies management and recommendation system can predict market trends and adjust strategies dynamically, ensuring that users' portfolios are always optimized according to changing market conditions. The application interface offers seamless access to comprehensive portfolio analytics, market updates, and actionable alerts, empowering users to make informed decisions quickly.

Furthermore, the investment strategies management and recommendation system ensure data security and privacy by segregating user data while providing independent access to personalized strategies. The system's ability to continuously monitor portfolios and automatically adjust recommendations, without manual intervention, greatly enhances efficiency and effectiveness in managing investments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content dictates otherwise. It should also be noted that the term “or” is generally employed in its broadest sense, that is, as meaning “and/or” unless the content dictates otherwise.

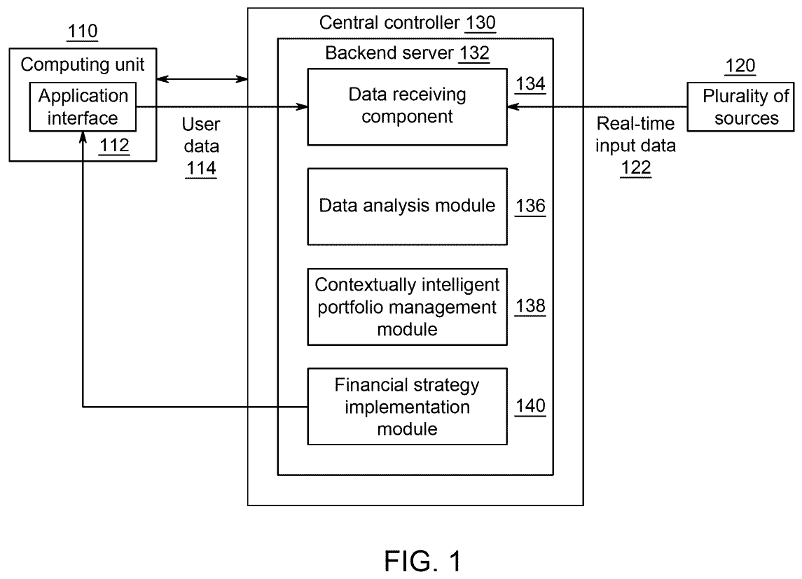

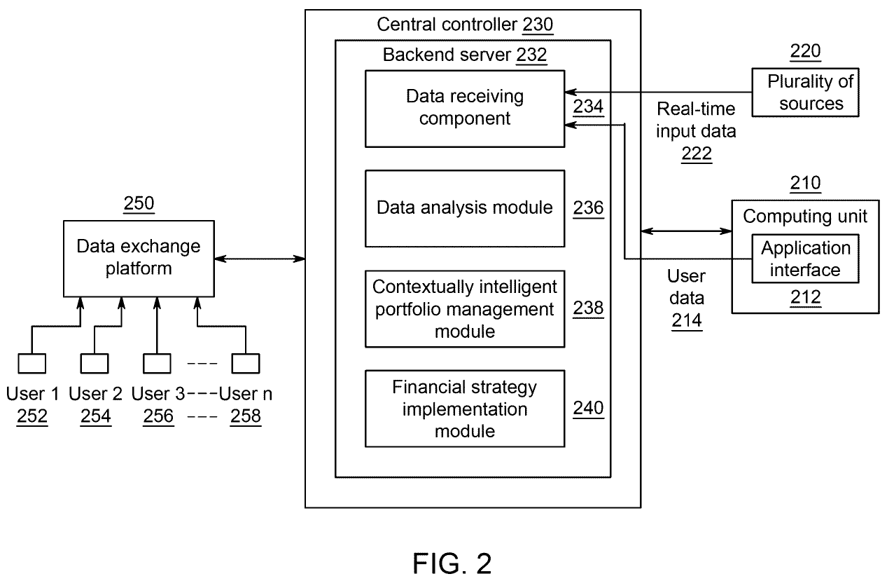

In description of the FIGS. 1-2 that follow, elements common to the schematic system will have the same number designation unless otherwise noted. In a first embodiment, as illustrated in FIG. 1, the present subject matter provides an integrated context aware investment strategies management and recommendation system 100.

The investment strategies management and recommendation system 100 exemplifies an advanced financial management framework that combines a computing unit 110 with an intelligent central controller 130 having a backend server 132, providing users with personalized investment strategies, real-time insights, and actionable recommendations. The investment strategies management and recommendation system 100 integrates multiple functionalities and technologies to update investment decisions, enhance user engagement, and ensure robust data security.

The computing unit 110 serves as a primary interface through which users interact with the investment strategies management and recommendation system 100. Equipped with an application interface 112, it provides seamless access to user data 114, which includes a wide range of categories, including, but not limited to, user profile data, investment history, behavioral data, preferences, user's contextual data, and real-time input data. Each of these data types plays a vital role in creating a complete understanding of the user's financial landscape. For instance, user profile data might include basic information such as name, contact details, and demographic attributes, forming the foundation of personalized services. Investment history tracks prior financial activities, like asset acquisitions, sales, and returns, enabling the system to analyze trends and provide historical insights. Behavioral data captures patterns in user decisions, such as their responses to market volatility, risk preferences, and investment frequency. User preferences specify individualized parameters like industries, asset types, or geographic regions for investments.

The backend server 132 is further adapted to receive a real-time input data 122, from a plurality of data-sources 120. The real time input data includes but is not limited to, continuously updated metrics such as market data, stock performance, asset valuations, user-specific contextual data for a plurality of users, and broader financial information. For example, the investment strategies management and recommendation system 100 might monitor stock price fluctuations, global commodity prices, interest rate changes, and regional economic news to offer users a detailed financial perspective. These data points are aggregated from the plurality of data-sources 120 including, but not limited to, such as user profiles, stock exchange databases, financial data providers, and trusted websites, creating a dynamic repository of information. This integration ensures users always have access to current, reliable, and actionable data.

At the core of the investment strategies management and recommendation system 100 is the central controller 130, which connects the computing unit 110 to the backend server 132, that ensures that data flows seamlessly across its components. The first key element of the backend server 132 is a data receiving component 134, which collects real-time input data 122 from the plurality of data-sources 120, and user data 114 from the application interface 112. The data receiving component 134 operates continuously, monitoring market conditions and synchronizing data from geographically distributed sources, such as global stock exchanges, financial institutions, and market analysis platforms. By consolidating data from diverse sources, the investment strategies management and recommendation system 100 offers a unified, global perspective on market trends. For instance, it could combine stock performance data from the New York Stock Exchange with cryptocurrency trends and commodity prices from Asian markets, enabling users to make well-informed, geographically agnostic decisions.

The backend server 132 further includes a data analysis module 136 adapted to processes and normalizes the input data 122 and user data 114, to extract actionable insights. In a preferred embodiment, the step of normalization involves standardizing data formats, removing duplicates, and categorizing information based on predefined criteria, such as asset classes, market sectors, or geographic regions. This ensures data integrity and relevance for further processing. Using machine learning algorithms, the data analysis module 136 analyzes historical patterns alongside current trends to predict potential market shifts. For example, by identifying correlations between global economic indicators and stock performance, the investment strategies management and recommendation system 100 can forecast future movements, helping users anticipate opportunities or risks. The data analysis module's 136 predictive capabilities continuously improve through adaptive learning, incorporating new data and feedback to refine insights over time.

The backend server 132 furthermore includes a contextually intelligent portfolio management module 138 adapted to builds on the actionable insights by continuously monitoring users' investments and asset portfolios. The contextually intelligent portfolio management module 138 generates real-time, contextually relevant portfolio information in correspondence to each user's goals and preferences. This includes tracking portfolio performance against user-defined metrics, such as risk thresholds and target returns. For instance, if a user's portfolio experiences significant fluctuations due to market volatility, the contextually intelligent portfolio management module 138 might generate alerts recommending adjustments, like reallocating assets to more stable options or capitalizing on emerging opportunities. By maintaining a real-time overview of portfolio dynamics, the investment strategies management and recommendation system 100 ensures users are always informed and can respond promptly to changes.

The backend server 132 furthermore includes a financial strategy implementation module 140 responsible for creating personalized investment strategies by combining actionable insights with contextually relevant portfolio information. The financial strategy implementation module 140 utilizes advanced algorithms to design strategies that align with users' financial goals, risk tolerance, and preferences. For instance, a user with a low-risk profile might receive recommendations focused on bonds, dividend-paying stocks, or other stable assets, while a high-risk tolerance might lead to suggestions involving equities, emerging market investments, of cryptocurrencies. The financial strategy implementation module 140 is dynamic, continuously refining its strategies based on the outcomes of past recommendations and user feedback. Analyzing the effectiveness of implemented strategies, ensures an iterative improvement process, enhancing the quality and relevance of its recommendations over time.

A key feature of the investment strategies management and recommendation system 100 is its ability to automatically manage, monitor, and recommend personalized investment strategies, which are visualized through the computing unit's application interface 112. The application interface 112 provides users with a comprehensive view of their financial landscape, including detailed portfolio analytics, real-time market updates, and actionable alerts. For instance, the application interface 112 might display a user's portfolio performance relative to market benchmarks, highlight sectors showing growth potential, or send notifications about significant market movements. These capabilities ensure that users remain informed and empowered to make timely decisions.

FIG. 2 depicts an exemplary embodiment showing the interconnection of a data exchange platform 250 with a central controller 230 for collaborating multiple users 252-258 with the computing unit 210. The example of such users includes but is not limited to at least one of consumer, retailer, banking and payment, enterprise and populations for providing them decision support and recommendations for a variety of purposes such as including but not limited to making investment decisions, managing portfolios, and complying with regulatory requirements. In such embodiments, the system data exchange platform may further include additional modules such as including but not limited to data governance module [not shown] for managing platform governance, manage stewardship, automate change approval, facilitate collaboration, enforce data policies and standards.

An exemplary embodiment of the investment strategies management and recommendation system 100 demonstrates the integration of a data exchange platform 250 with a central controller 230 to facilitate seamless collaboration among a plurality of users 252-258 through a computing unit 210. The data exchange platform 250, represented as a distinct module, is communicably connected to the central controller 230. This connection allows the data exchange platform 250 to act as a centralized hub for real-time data exchange and interaction. The primary purpose of this setup is to enable the plurality of users 252-258, such as individual investors, portfolio managers, financial advisors, or family offices, to collaboratively manage investment and asset portfolios efficiently and securely.

The data exchange platform 250 can be accessed by plurality of users 252-258, in this embodiment, who can interact with it through an application interface 212 of the computing unit 210. For instance, individual investor may collaborate with their financial advisor to review current portfolio performance and discuss investment strategies. Similarly, a family office manager might use the data exchange platform 250 to share real-time insights and reports with other stakeholders or clients. By utilizing the central controller 230, the data exchange platform 250 ensures all interactions are synchronized, allowing the plurality of users 252-258 to exchange ideas, analyze market trends, and make informed decisions collectively.

This interconnected system also supports real-time updates and notifications, enabling users to act promptly on critical market changes. For example, if the central controller 230 detects a significant market fluctuation, it can relay actionable insights to all connected users via the data exchange platform 250. Additionally, the data exchange platform 250 enforces stringent data privacy and access controls, ensuring that sensitive financial information is shared only with authorized individuals. Through this design, the embodiment demonstrates how the data exchange platform 250 and central controller 230 work in tandem to provide a collaborative, transparent, and secure environment for managing investments and assets.

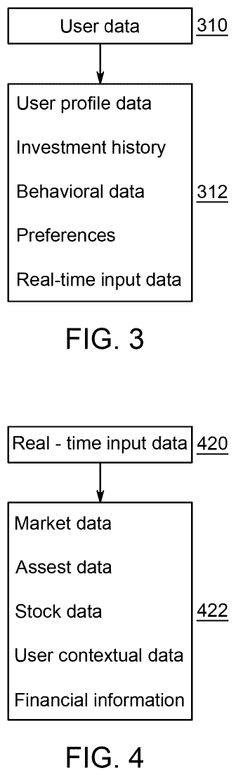

FIG. 3 depicts exemplary user data 310 used for the generation of personalized recommendation strategies.

The user data 310 forms the backbone of personalized recommendation strategies by providing a complete and dynamic profile of users' financial habits, preferences, and behaviors. The user data 310 is aggregated from the application interface, each adding depth and precision to the generated recommendations. The user data 310 includes, but is not limited to, multiple data sets 312, including, user profile data, investment history, behavioral data, preferences, and real-time user input.

User profile data includes static attributes such as age, income, geographic location, and long-term financial goals. For example, a 30-year-old professional with a high-risk appetite and plans to buy a house in five years might receive recommendations focusing on growth-oriented assets like tech stocks or ETFs, balanced with moderate-risk bonds to preserve capital for their future home purchase. Further, in some embodiments, the user's data may include user's contextual data derived from a plurality of user's devices. Example of contextual data is elaborated later in the document.

Investment history captures details of past investment patterns, including asset allocation, returns, and portfolio diversification. If a user has consistently invested in technology stocks with high returns, system 100 might prioritize similar investments but also suggest diversification into emerging markets or sustainable funds to mitigate sector-specific risks. For instance, if their history shows a lack of exposure to healthcare, system 100 might highlight growth opportunities in that sector.

Behavioral data reflects the user's engagement with the computing unit, including browsing habits, frequently viewed asset classes or actions like responding to alerts. For instance, if a user frequently explores green energy investments but has yet to commit, system 100 might proactively recommend ESG-compliant funds or provide curated content about sustainable investment benefits.

Preferences incorporate explicit inputs, such as the user's stated goals, and inferred insights derived from their actions. For example, a user specifying a preference for high liquidity might receive recommendations for assets like money market funds or actively traded stocks, while avoiding long-term lock-ins like real estate or fixed deposits.

Real-time input ensures that recommendations align with current market conditions, drawing on live updates such as stock prices, market indices, or geopolitical events. For example, if crude oil prices surge and the user has investments in the energy sector, system 100 might suggest rebalancing their portfolio to reduce exposure or exploit the upward trend.

FIG. 4 depicts real-time input data 420 provided to the data receiving component through the computing unit.

Real-time input data 420 plays a pivotal role in ensuring that the generated recommendations are timely, accurate, and relevant to the user's investment objectives. The real-time input data 420, is provided to the data-receiving component through a plurality of data-sources. The real-time input data 420 includes multiple categories 422, each contributing to the overall decision-making process. By integrating diverse datasets such as market data, asset data, stock data, user contextual data, and financial information, system 100 creates a detailed, dynamic foundation for generating personalized investment strategies.

Market data includes macroeconomic indicators, such as inflation rates, interest rates, GDP growth, and global economic trends. For example, during an economic downturn indicated by declining GDP and rising unemployment, the system 100 might prioritize low-risk investments like government bonds or defensive stocks in sectors such as utilities and healthcare.

Asset data pertains to details about various asset classes, such as real estate, commodities, mutual funds, and exchange-traded funds (ETFs). If system 100 detects rising real estate prices in a specific geographic region, it may recommend investment opportunities in real estate investment trusts (REITs) or highlight the potential benefits of diversifying into property markets.

Stock data encompasses livestock prices, trade volumes, earnings reports, and corporate announcements. For instance, if a company announces better-than-expected quarterly earnings, system 100 might identify it as a high-growth opportunity for the user. Conversely, it could generate alerts to sell or avoid stocks experiencing sharp declines due to poor earnings or management issues.

User contextual data considers user-specific real-time circumstances, such as changes in income, spending patterns, or significant life events like marriage or retirement planning. For example, if a user reports a salary increase, system 100 might suggest increasing their investment allocation toward growth-oriented assets to capitalize on the higher disposable income. The user contextual data can be received from any compatible devices, including, IoT devices, sensors, intelligent edge devices, and so on. These devices are located within the proximity where the user moves or locates. Contextual data of the user refers to a comprehensive set of information that provides insights into the user's unique circumstances, preferences, and behaviors, which are critical for tailoring investment strategies and recommendations. The user contextual data includes demographic details such as age, location, occupation, and financial background, which help in understanding the user's financial needs and goals. It also incorporates behavioral patterns, including how the user interacts with the application, preferred devices or interfaces (e.g., mobile, web, VR), and the types of financial products or services they explore. Contextual data further captures the user's risk appetite, derived from historical investment decisions and their tolerance for financial risks. Additionally, it integrates market sentiment and real-time economic indicators relevant to the user's investments, along with personal milestones such as retirement, marriage, or education planning. Geographical context plays a role in identifying regional opportunities or constraints, while portfolio-specific details highlight the current composition and performance of the user's investments.

Financial information integrates broader datasets such as interest rates, currency exchange rates, and commodity prices. If the system 100 observes a strong U.S. dollar and falling gold prices, it might suggest reducing exposure to gold investments while exploring opportunities in dollar-denominated assets like U.S. Treasury bonds.

For instance, suppose a user has a portfolio predominantly composed of U.S. technology stocks. If real-time input data shows an interest rate hike by the Federal Reserve (market data), coupled with a significant drop in tech stock prices (stock data), the system 100 might recommend reallocating funds to sectors less sensitive to interest rate changes, such as energy or healthcare (asset data). Simultaneously, considering the user's upcoming retirement (user contextual data), the system could suggest shifting part of the portfolio into lower-risk fixed-income investments (financial information).

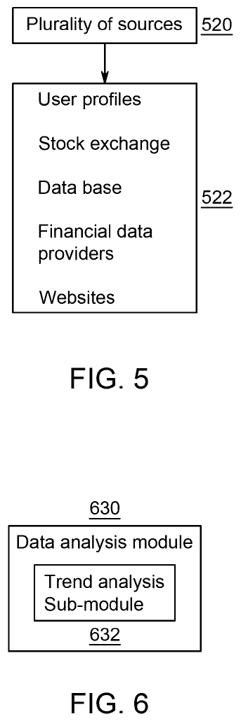

FIG. 5 depicts a plurality of data sources 520 from where the real-time input data is received.

The plurality of data-sources 520 from which real-time input data is received to generate accurate and personalized investment strategies. The plurality of data-sources 520 include user profiles, stock exchange databases, financial data providers, and websites 522, each contributing vital information that helps the system deliver personalized recommendations to users.

User profiles provide personalized data that reflect an individual's investment history, financial goals, preferences, and risk tolerance. For example, a user profile may reveal that an investor prefers low-risk, stable investments or is focused on long-term growth. This data allows the system 100 to customize recommendations based on the user's unique preferences, ensuring that the advice provided aligns with their financial objectives.

Stock exchange databases, such as those from major exchanges like the NYSE or NASDAQ, supply real-time market data including stock prices, trading volumes, earnings reports, and corporate news. For instance, If a stock experiences a sharp drop in price due to an unexpected market event, system 100 can utilize this information to alert the user or adjust their portfolio accordingly, taking advantage of potential opportunities or minimizing risks.

Financial data providers like Bloomberg, Reuters, and Morningstar contribute high-level macroeconomic data, such as interest rates, inflation statistics, GDP growth, and sector performance. This data enables system 100 to understand broader market trends and economic conditions that could affect the user's investments, providing them with insights on potential shifts in the market.

Websites, including financial news platforms, blogs, and other online sources, add a layer of contextual and real-time data. For example, news articles on major geopolitical events or new regulations could directly influence asset prices, and by monitoring these sources, system 100 can provide relevant alerts or adjust investment strategies in response to changing conditions.

The plurality of data-sources 520 ensures that system 100 has access to a broad spectrum of data, ranging from the user's financial situation to macroeconomic trends, allowing for real time, accurate, and personalized investment recommendations.

FIG. 6 depicts various sub-modules of the data analysis module 630.

A trend analysis sub-module 632, part of the data analysis module 630, is a component that plays a crucial role in identifying patterns and correlations within large volumes of received data, enabling the system to predict future market behavior. By processing and analyzing both historical and current data, the trend analysis sub-module 632 serves as the system's predictive engine, allowing it to forecast potential market trends and asset movements. The trend analysis sub-module 632 employs a combination of traditional statistical analysis, machine learning algorithms, and artificial intelligence techniques to examine various data types and recognize underlying patterns that indicate future market directions.

The trend analysis sub-module 632 aggregates multiple data inputs, such as historical price data, trading volumes, economic indicators, news sentiment, and even social media trends. These diverse sources provide a rich data set for the trend analysis sub-module 632 to analyze. For example, if the trend analysis sub-module 632 receives real-time data indicating a consistent upward trend in the price of a specific stock over several weeks, paired with improving economic indicators related to that sector (such as increasing demand for the company's products or services), the trend analysis sub-module 632 would identify a positive correlation. This correlation may indicate that the stock is likely to continue its upward movement, and the trend analysis sub-module 632 could recommend a buying strategy for the investor.

In addition to identifying positive trends, the trend analysis sub-module 632 is adept at recognizing emerging risks and negative trends in the market. For instance, if there is a sudden and significant decline in the price of a stock, coupled with negative news about the company, such as a scandal or an unexpected regulatory change, the trend analysis sub-module 632 will detect this as a bearish trend. The trend analysis sub-module 632 would then recommend either selling the asset or adjusting the portfolio to mitigate the risk. Furthermore, the trend analysis sub-module 632 is not limited to analyzing individual assets but also looks for patterns across entire markets, sectors, or economies. By detecting these broader patterns, the system can anticipate shifts in the financial landscape, such as potential recessions, sectoral slowdowns, or booming industries, allowing it to provide users with actionable insights for portfolio adjustment.

The trend analysis sub-module 632 also utilizes machine learning techniques to continuously improve its accuracy. Over time, the trend analysis sub-module 632 learns from previous patterns and predictions, refining its ability to recognize subtle market changes and adapt to new economic conditions. For example, if the system observes a consistent failure in predicting stock movements in a particular industry, it can re-adjust its algorithms to account for new variables or shifts in investor behavior. This ongoing learning process ensures that the trend analysis sub-module 632 remains relevant and accurate, even as market conditions evolve.

Moreover, the trend analysis sub-module 632 doesn't merely recognize trends in isolation but also contextualizes them by analyzing interdependencies between different types of data. For example, the trend analysis sub-module 632 might detect a correlation between an economic indicator, such as rising inflation, and a stock's performance in a specific industry, such as consumer goods. This allows the system to predict that companies within that sector may experience increased costs and reduced profitability, suggesting that the user should reconsider holding those stocks.

Finally, the trend analysis sub-module 632 provides a predictive view of the market, giving users a proactive advantage. Rather than waiting for the market to react to events, the system anticipates shifts and recommends strategies to adjust the user's portfolio ahead of time. This predictive capability is invaluable for users seeking to make well-timed investment decisions, improving the overall effectiveness of the personalized investment strategies generated by the system. By helping investors navigate potential market fluctuations and identify opportunities in advance, the trend analysis sub-module 632 plays an essential role in the system's ability to offer data-driven, personalized financial advice that is both timely and actionable.

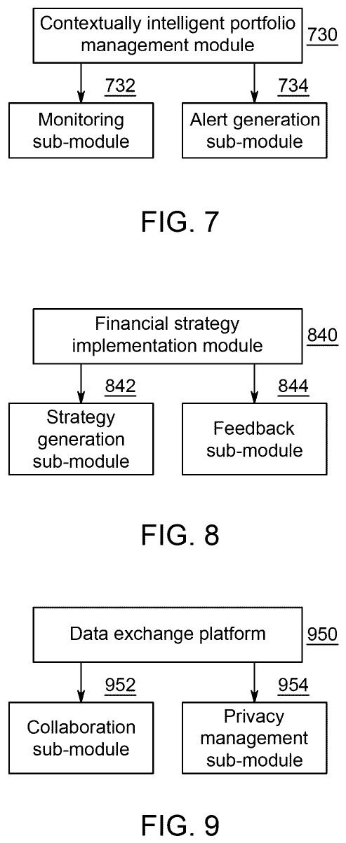

FIG. 7 depicts various sub-modules of the contextually intelligent portfolio management module 730.

The contextually intelligent portfolio management module 730 is a critical component of the system, responsible for ensuring that users' investment portfolios are continuously monitored and adjusted in real-time based on market conditions and predefined goals. The contextually intelligent portfolio management module 730 comprises two essential sub-modules, namely, the monitoring sub-module 732 and the alert generation sub-module 734, both working together to enhance the accuracy and responsiveness of the portfolio management system.

The monitoring sub-module 732 is designed to track the performance of the user's portfolio in real-time, ensuring that it is aligned with both market trends and the specific investment goals set by the user. The monitoring sub-module 732 continuously compares the performance of individual assets, sectors, and the entire portfolio to a variety of market indicators such as price fluctuations, asset performance, sector-wide trends, and macroeconomic factors. For example, if a user's portfolio holds stocks from the technology sector, the monitoring sub-module 732 will track the sector's overall performance, considering factors like market growth, interest rates, or technological advancements that could affect stock prices. If the technology sector experiences significant changes, such as a boom in demand for a new tech product, the monitoring sub-module 732 will track how these changes influence the portfolio's performance relative to the broader market.

The monitoring sub-module 732 also checks how the portfolio is performing against the user's predefined financial goals, which could include retirement savings, wealth accumulation, or specific investment return targets. If the user has set a goal of achieving a 10% annual return, the monitoring sub-module 732 will continuously assess the portfolio's progress toward this target by calculating returns and comparing them with the expected benchmarks. If the portfolio's performance falls below the expected level, an alert or recommend portfolio adjustments to realign the investment strategy with the user's goals.

The second key sub-module, the alert generation sub-module 734, is responsible for providing real-time notifications to the user based on critical market events of significant changes in their portfolio. The alert generation sub-module 734 ensures that users remain informed about important developments that could impact their investments, such as drastic shifts in asset prices, sudden market fluctuations, or external factors like geopolitical events or natural disasters that could disrupt financial markets. For example, if a stock in the user's portfolio undergoes a sudden price drop due to an unexpected earnings report or negative news about the company, the alert generation sub-module 734 will send a real-time notification, informing the user about the specific change and its potential impact on the portfolio.

In addition to reacting to negative events, the alert generation sub-module 734 can also notify users of positive opportunities. For instance, if an asset in the portfolio shows signs of significant growth or a new market opportunity arises, such as a merger or acquisition that could boost the stock price, the system will inform the user immediately. These alerts ensure that users can take prompt action when required, whether it's selling an underperforming asset, rebalancing the portfolio, or capitalizing on a new investment opportunity.

The alert generation sub-module 734 can be configured to deliver notifications through various channels, such as push notifications, emails, or in-app messages, ensuring users stay up-to-date on their portfolio's status, regardless of their location or preferred communication method. The notifications can be customized based on the user's preferences, including the frequency and type of alerts they wish to receive. For example, a user may opt to receive only high-priority alerts regarding major market events or could set the system to notify them whenever a stock reaches a specific price threshold.

Together, these two sub-modules work seamlessly to provide users with a holistic view of their portfolio's performance and market dynamics. The monitoring sub-module 732 ensures that the portfolio remains aligned with market trends and user-defined goals, while the alert generation sub-module 734 keeps the user informed of critical developments, enabling them to make timely and informed investment decisions. The combination of continuous monitoring and real-time alerts ensures that users are always in control of their investments, allowing them to respond quickly to market conditions and optimize their portfolio's performance.

FIG. 8 depicts various sub-modules of the financial strategy implementation module 840,

The financial strategy implementation module 840 is a key component of the system designed to create, adjust, and optimize personalized investment strategies for users. The financial strategy implementation module 840 utilizes actionable insights, user preferences, and past performance data to develop investment strategies that align with the user's financial goals. The financial strategy implementation module 840 consists of two critical sub-modules, namely, a strategy generation sub-module 842 and a feedback sub-module 844. Together, these sub-modules ensure that the system not only generates personalized strategies but also evolves them based on real-world outcomes and user behavior.

The strategy generation sub-module 842 creates personalized investment strategies in correspondence to the user's preferences, risk tolerance, financial goals, and insights derived from real-time data analysis. Using input data from various sources, such as the user's profile, historical investments, and current market conditions, the strategy generation sub-module 842 formulates a strategy that is designed to meet the user's objectives, whether it be long-term wealth accumulation, retirement planning, or short-term gains. For instance, if a user's portfolio has a conservative risk profile and is focused on steady growth, the strategy generation sub-module 842 will prioritize low-risk assets, such as blue-chip stocks, bonds, and dividend-paying stocks, while avoiding high-volatility assets like speculative tech stocks or cryptocurrencies.

The strategy generation process involves analyzing a wealth of data, including market trends, asset correlations, and predictive insights from the data analysis module. The strategy generation sub-module 842 uses this information to create a diversified investment strategy that takes into account the user's goals, such as maximizing returns while managing risk. For example, a user who is nearing retirement might have a strategy that prioritizes low-risk bonds and income-generating assets, while a younger user might be more open to riskier growth assets like emerging market stocks or start-up investments.

The feedback sub-module 844, on the other hand, is tasked with refining and improving investment strategies by continuously analyzing the outcomes of past recommendations and user interactions. The feedback sub-module 844 evaluates how well previous strategies have performed based on the user's feedback, market fluctuations, and portfolio performance. The feedback sub-module 844 identifies whether the user's investment goals are being met and whether the strategies need adjustments. For example, if a particular recommendation to invest in a stock or bond does not meet the user's expectations or falls short of their goal, the feedback sub-module 844 will take note of the underperformance, and adjust future strategies accordingly. Additionally, the feedback mechanism considers the user's interactions with the recommendations, such as whether the user accepted or rejected certain strategies, to fine-tune future proposals and align more closely with the user's preferences.

One of the key features of the feedback sub-module 844 is its ability to learn from both the outcomes of past investment strategies and the user's behavior over time. This iterative learning process allows the system to continuously improve its recommendations. For instance, if a user frequently adjusts their portfolio to avoid highly volatile stocks, the system will learn this preference and suggest more conservative assets in future strategies. Similarly, if a user expresses satisfaction with a particular strategy that involves growth stocks, the system will prioritize similar high-growth opportunities in the future.

Together, the strategy generation sub-module 842 and the feedback sub-module 844 work in tandem to ensure that the financial strategy implementation module creates highly personalized, adaptive, and data-driven investment strategies. The strategy generation sub-module 842 ensures that strategies are initially personalized to the user's preferences and goals, while the feedback sub-module 844 refines those strategies over time based on real-world performance, market changes, and user interactions.

FIG. 9 depicts various sub-modules of the data exchange platform 950.

The data exchange platform 950 is an integral part of the system that enables secure and efficient interaction among users, providing collaboration while maintaining stringent privacy controls. The data exchange platform 950 facilitates seamless sharing of investment insights, strategies, and performance metrics, enhancing the overall user experience. The data exchange platform 950 is supported by two crucial sub-modules: the collaboration sub-module 952 and the privacy management sub-module 954. These sub-modules work in tandem to ensure that users can engage in meaningful collaboration while safeguarding sensitive data and adhering to financial privacy regulations.

The collaboration sub-module 952 is designed to promote real-time communication and sharing of investment-related information among users, such as family members, friends, or financial advisors. Through the collaboration sub-module 952, users can securely share their portfolio details, discuss investment strategies, or seek advice from trusted individuals. For example, a user might invite a family member to review their portfolio to ensure alignment with long-term family financial goals, such as saving for a child's education. Similarly, a user could consult a financial expert by granting them temporary access to their portfolio details through the platform, enabling the expert to provide personalized advice.

This collaboration functionality extends to group discussions, where multiple users can connect and share insights on market trends or investment opportunities. For instance, a group of friends who share an interest in stock trading could use the data exchange platform 950 to exchange ideas, discuss potential investments, or collectively analyze market data. Additionally, users can utilize the collaboration sub-module 952 to share customized reports generated by the system, allowing them to highlight specific aspects of their portfolios, such as high-performing assets or diversification strategies. These capabilities are seamlessly integrated into the computing unit, enabling users to collaborate directly from the application interface.

The privacy management sub-module 954 ensures that collaboration occurs within a secure and controlled environment by enforcing strict data-sharing permissions and complying with financial privacy regulations. Users have full control over what information they choose to share and with whom. For instance, a user can grant a financial advisor access only to specific parts of their portfolio, such as equity holdings, while keeping sensitive data like bank account details hidden. The privacy management sub-module 954 also supports granular permission settings, allowing users to define time-limited access or restrict sharing to certain data types, ensuring that their information remains protected.

Furthermore, the privacy management sub-module 954 enforces compliance with financial privacy regulations, such as the General Data Protection Regulation (GDPR) or similar laws, depending on the user's location. The privacy management sub-module 954 ensures that shared data is encrypted and securely transmitted, preventing unauthorized access. For example, when a user collaborates with an advisor, the system ensures that all communications are encrypted and that the advisor's access is automatically revoked after the agreed-upon time frame.

By integrating the collaboration sub-module 952 and the privacy management sub-module 954, the data exchange platform 950 strikes a balance between enabling meaningful collaboration and safeguarding user data. This empowers users to make more informed investment decisions by leveraging collective insights while maintaining full control over their privacy.

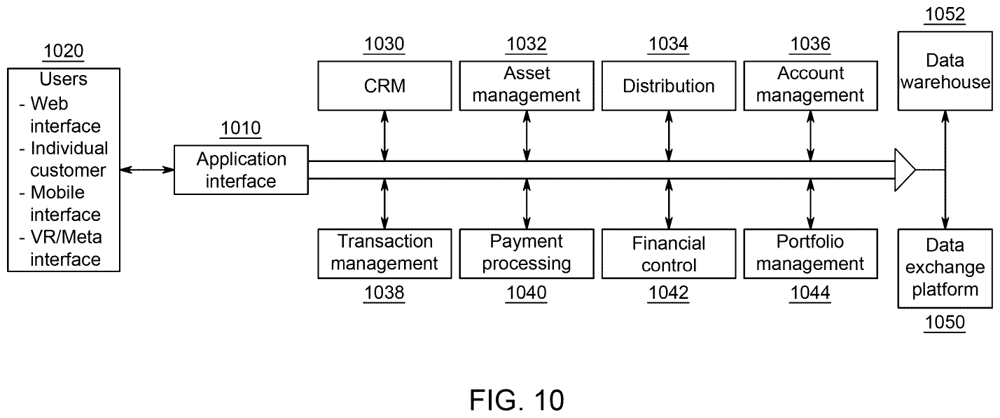

FIG. 10 depicts the workflow of the investment strategies management and recommendation system.

The system enables multiple types of users 1020, such as those using a web interface, individual customers, mobile interfaces, and even virtual reality (VR) or metaverse interfaces, to connect communicably to the application interface 1010. The application interface 1010 serves as the central hub for various financial management tasks, performing a wide range of functions essential for investment and asset management. These functions include Customer Relationship Management (CRM) 1030, which handles user interactions and engagement; asset management 1032, responsible for overseeing the assets in a user's portfolio; distribution 1034, which ensures the proper distribution of resources; account management 1036, where user account details are handled and updated; transaction management 1038, which tracks and processes financial transactions; payment processing 1040, which facilitates seamless payments; financial control 1042, overseeing the financial health and security of user assets; and portfolio management 1044, which focuses on the strategic management of user portfolios to optimize returns. After performing these functions, all relevant data and user-specific information are securely transmitted to the data exchange platform 1050 and stored in a data warehouse 1052. This ensures that the data is organized, archived, and accessible for further processing, analysis, and decision-making, enhancing the overall efficiency of the system.

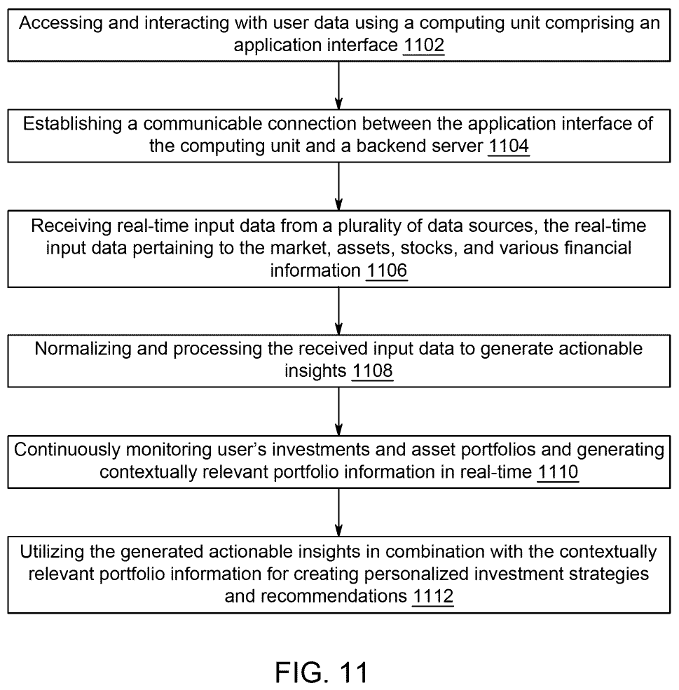

FIG. 11 depicts an exemplary investment strategies management and recommendation process 1100 for users.

Step 1102 accesses and interacts with user data using a computing unit comprising an application interface.

The process 1100 begins with accessing and interacting with user data through a computing unit equipped with an application interface. This application interface enables the system to securely connect with the user and collect relevant personal and financial data. The user data collected at this stage includes a variety of information such as user profile data (e.g., age, income level, and financial goals), investment history (e.g., records of past transactions and portfolio adjustments), behavioral data (e.g., user's risk tolerance, investment preferences, and decision-making patterns), and real-time input data (e.g., dynamically changing financial information).

The next step involves collecting real-time input data, which serves as the foundation for creating accurate and timely financial insights. This input data incorporates market data (e.g., stock indices, commodity prices, and interest rate trends), asset data (e.g., current valuations of owned properties or investment instruments), stock data (e.g., prices and performance trends), user contextual data (e.g., specific investment scenarios or time-sensitive needs), and various financial information (e.g., macroeconomic indicators or policy changes).

To gather all this information, the system utilizes a plurality of data-sources. These sources include user profiles (to integrate personal investment goals and preferences), stock exchange databases (for up-to-date stock market information), financial data providers (offering insights on market trends, indices, and asset values), and websites (for additional financial news, blogs, or analytics). This ensures seamless data aggregation from these diverse sources, enabling a holistic and comprehensive approach to financial analysis and recommendation.

Step 1104 establishes a communicable connection between the application interface of the computing unit and a backend server.

The step of establishing a communicable connection between the application interface of the computing unit and a backend server forms the backbone of the system's architecture, enabling seamless data exchange and real-time interaction. This connection begins with the computing unit, such as a user's mobile device or desktop computer, which houses an application interface specifically designed to interact with the user. The application interface acts as the primary gateway through which users input their data, access recommendations, and receive notifications.

On the other end of this connection is the backend server, a robust and scalable infrastructure designed to handle complex data processing and management tasks. The backend server hosts critical system components such as the data receiving component, data analysis module, portfolio management module, and strategy implementation module, ensuring efficient processing of input data and generation of actionable insights.

To establish this connection, secure communication protocols such as HTTPS or encrypted APIs are employed, ensuring the confidentiality and integrity of the data being transmitted. For instance, when a user submits real-time inputs like updated investment preferences or queries market insights through the application interface, these inputs are securely transmitted to the backend server. The server, in turn, processes this data and responds with relevant outputs, such as personalized portfolio adjustments or actionable market alerts, which are displayed on the user's application interface.

This communicable connection also supports bidirectional data flow. It enables real-time synchronization of user activities with backend processes while allowing the backend server to push critical notifications and recommendations directly to the user. The established connection ensures that users experience minimal latency, enabling them to make informed investment decisions promptly. Additionally, this setup facilitates continuous monitoring of the user's portfolio and market trends, ensuring the system remains responsive and contextually aware at all times.

Step 1106 receives real-time input data from a plurality of data sources, the real-time input data pertaining to the market, assets, stocks, and various financial information.

The step of receiving real-time input data from a plurality of data sources is a critical component of the system, ensuring that the backend server has access to the most up-to-date and relevant information for processing and analysis. The real-time input data encompasses a wide array of information, including market trends, asset performance, stock prices, and various other financial details, which serve as the foundation for generating personalized investment strategies and actionable insights.

This input data is collected from the plurality of data sources, which includes diverse and reliable channels such as stock exchange databases, financial data providers, user profiles, and financial websites. For instance, stock exchange databases provide real-time updates on stock prices, trade volumes, and market indices, while financial data providers supply curated and in-depth analyses of market conditions, economic trends, and asset behaviors. Websites and news platforms contribute additional context, offering updates on macroeconomic events, company news, or regulatory changes that could influence market dynamics.

The system employs a data-receiving component within the backend server to handle this incoming data. This component is configured to seamlessly integrate with APIs and data feeds provided by these sources, ensuring continuous data flow without manual intervention. For example, if a significant event such as an interest rate announcement occurs, the system immediately captures the related market fluctuations from stock exchanges and financial news platforms.

Moreover, the real-time nature of this input data ensures that the system remains agile and responsive. By continuously monitoring and synchronizing data from geographically distributed sources, the backend server maintains a comprehensive and global perspective on financial trends. This capability is essential for providing users with timely recommendations that reflect current market realities.

To enhance accuracy and reliability, the data validation mechanisms is employed to filter out incomplete, duplicate, or inconsistent entries before further processing. By ensuring that only high-quality data is processed, the system guarantees that its insights and recommendations are grounded in accurate and trustworthy information.

Step 1108 normalizes and processes the received input data to generate actionable insights.

The step of normalizing and processing received input data is critical for transforming raw, unorganized information from multiple sources into structured, meaningful insights that guide investment strategies. The first step in this process is data normalization, which involves removing duplicate or inconsistent data entries to ensure accuracy and reliability. For instance, when market data is aggregated from various sources such as stock exchange databases and financial data providers, discrepancies like differing stock prices or incomplete information can arise. The system identifies and resolves these issues, consolidating data into a unified, accurate dataset that forms the foundation for further analysis.

Following normalization, the system proceeds to categorize the input data based on predefined criteria. This categorization makes the data more manageable and actionable by organizing it into meaningful groups such as asset classes (e.g., equities, bonds, and commodities), geographic regions (e.g., North America, Asia, and Europe), or market sectors (e.g., technology, healthcare, and energy). For example, financial information about various stocks is grouped by industry, enabling the system to identify sector-specific trends or investment opportunities. Similarly, international market data is sorted by region, allowing for targeted analysis of global financial landscapes.

Once the data has been normalized and categorized, the system applies advanced analytical methods to generate actionable insights. This includes identifying investment opportunities based on real-time input data, such as undervalued assets or emerging market trends. Additionally, the system uses machine learning algorithms trained on historical data to predict potential market shifts. For instance, by analyzing past trends in stock performance and current market conditions, the system can anticipate future price movements or volatility. These insights are tailored to individual user profiles, providing precise and timely recommendations that align with their investment goals and preferences. This comprehensive process ensures that the user receives reliable, contextually relevant insights for making informed investment decisions.

Step 1110 continuously monitors the user's investments and asset portfolios and generates contextually relevant portfolio information in real-time.

The step of continuously monitoring a user's investments and asset portfolios is pivotal for delivering contextually relevant and dynamic portfolio information in real-time. This monitoring ensures that users are always informed about the status and performance of their financial holdings, allowing them to make timely decisions. The system achieves this by tracking portfolio value changes in response to real-time market fluctuations, leveraging its connection to multiple data sources such as stock exchanges, financial data providers, and market analysis platforms. For instance, if a user's portfolio includes stocks, the system monitors the stock prices as they change throughout the trading day, updating the portfolio's overall value accordingly. Similarly, if the portfolio contains assets like bonds or mutual funds, the system tracks their performance based on interest rates, market demand, and other relevant factors.

In addition to tracking changes, the system is equipped to generate alerts for deviations from user-defined risk thresholds or performance targets. This functionality is essential for proactive portfolio management. For example, a user may set a risk threshold that specifies acceptable levels of volatility for their portfolio. If a market fluctuation causes a significant deviation from this threshold—such as a stock's value dropping by 10% in a single day—the system immediately notifies the user. Similarly, performance targets such as achieving a 15% annual return on investments are monitored. If the portfolio's progress toward these targets diverges, the user is alerted promptly.

This continuous monitoring and alerting mechanism ensure that the user remains aware of any critical changes in their portfolio's performance and market conditions, By providing contextually relevant information—such as explaining how a specific market trend affects a particular asset—the system enables users to react quickly to opportunities or mitigate potential losses. This real-time, dynamic capability fosters smarter investment decisions and better alignment with the user's financial goals and risk appetite.

Step 1112 utilizes the generated actionable insights in combination with the contextually relevant portfolio information for creating personalized investment strategies and recommendations.

Utilizing the generated actionable insights in combination with contextually relevant portfolio information is a crucial step in creating personalized investment strategies and recommendations. The actionable insights are derived from the processed real-time input data, such as market trends, asset performance, and user preferences. These insights provide a deep understanding of potential investment opportunities, risks, and market shifts. For instance, the system might identify that a particular sector, such as technology, is poised for growth based on real-time market data, historical trends, and predictive analysis. At the same time, the contextually relevant portfolio information includes the current state of the user's investments, such as the distribution of their portfolio across various asset classes (e.g., stocks, bonds, commodities), their risk tolerance, and their financial goals.

By combining these insights and portfolio details, the system can create highly personalized investment strategies that align with the user's objectives. For example, if the system identifies an emerging market trend that aligns with the user's risk tolerance and long-term growth objectives, it can recommend increasing the allocation in specific stocks or sectors that are likely to benefit from this trend. Similarly, if the portfolio is overly concentrated in one asset class, the system may suggest diversifying the portfolio by introducing new asset types, such as international stocks or commodities, to better balance risk and return potential.

Moreover, the system can tailor recommendations based on the user's behavioral data, preferences, and past investment decisions. For instance, if a user prefers low-risk investments or has historically shown interest in socially responsible investing, the system will prioritize suggestions that align with these preferences. Through this comprehensive analysis of insights, user data, and contextual portfolio information, the system ensures that each investment strategy and recommendation is personalized, actionable, and relevant to the user's unique financial profile and goals. This approach allows users to make more informed, targeted investment decisions that can optimize portfolio performance while staying aligned with their risk tolerance and future aspirations.

Finally, the personalized investment strategies are automatically managed, monitored & recommended/visualized onto the application interface of the computing unit.

Automatically managing, monitoring, and recommending personalized investment strategies onto the application interface of the computing unit is a key function of the system. Once the system has analyzed the user's data and generated actionable insights, it takes a proactive approach to managing the user's portfolio by continuously monitoring market conditions, user goals, and portfolio performance. This process involves updating the application interface in real-time with relevant information, such as changes in the portfolio value, new investment opportunities, and alerts for market shifts. The system's ability to automatically adjust and visualize these personalized strategies on the interface allows users to seamlessly track the performance of their investments and make decisions based on up-to-date data. For example, if the system detects a significant market change that could impact the user's portfolio, it can automatically update the interface with recommended actions, such as reallocating assets or adjusting risk exposure.

User feedback plays an important role in refining investment strategies. The system analyzes the outcomes of past recommendations and user interactions to improve future suggestions. By evaluating the success or failure of previous investment strategies—such as whether a recommended stock performed as expected or whether the user met their financial goals—the system can learn and adapt. For instance, if a user's investment in a particular stock didn't yield the anticipated return, the system can take note of this and adjust future recommendations by considering factors that were overlooked or misunderstood in the previous analysis. Additionally, the system can personalize its recommendations based on user preferences, behavior, and changing financial goals, ensuring that each strategy evolves with the user's needs.

The system also ensures that users have the ability to independently access their personalized investment strategies while maintaining data segregation and security. While the system provides automated recommendations, users are empowered to make their own decisions and access detailed information about their portfolios at any time. The application interface allows users to explore various aspects of their investment strategies, including real-time performance metrics, historical data, and the potential impact of new recommendations. To safeguard privacy, the system enforces data segregation policies that keep each user's financial information separate from others, ensuring that sensitive data is not shared or compromised. Robust security measures, such as encryption and user authentication, are employed to protect both the user's data and the integrity of their investment strategies. This ensures that users can confidently manage their investments. while maintaining control over their data, knowing that their information is secure.

### IMPLEMENTATION

Designing, developing, and deploying a comprehensive database schema for a multi-tier AI-driven computing unit requires careful planning and a structured approach The schema must be scalable, support automation, and ensure seamless integration across various system components. Here's a breakdown of the process to design, develop, and deploy such computing unit, with a focus on both the database schema and the steps for platform deployment.

### 1. Database Design

The database schema is the foundation of the computing unit, and it must support complex relationships between different tables and entities. The design begins by identifying the core modules and their respective components, including Platform User Tables, Investment Management Tables, AI Management Tables, Family Office and Professional Investor Managers Tables, Management Teams Tables, and Reporting and Insights Tables.

Platform User Tables: These tables store user-specific information. The Users table contains basic details such as User_ID, Name, and Email, along with an encrypted password for security. It also specifies the role of the user (e.g., individual investor, professional investor). The User_Profile table is linked to the Users table and stores more detailed information, such as contact details and preferred investment strategies, allowing for personalization.

Investment Management Tables: These tables track the user's investment portfolios and the assets contained within them. The Investment_Portfolio table links each portfolio to a user and details the portfolio's name, type, and management style (e.g., AI-managed or human-managed). The Investment_Assets table captures each asset's type (equities, bonds, real estate) and their current value, enabling detailed tracking and analysis of portfolio performance.

AI Management Tables: The AI_Models table stores data related to the different AI models used by the platform (e.g., risk analysis or return optimization models). The AI_Analysis_History table stores historical analysis results for each portfolio, including the model used, the date of analysis, and the result of the analysis, which can inform future strategies.

Family Office and Professional Investor Managers Tables: The Offices table records information about investment offices (e.g., family offices or professional investor firms). The Office_Portfolios table links offices with the investment portfolios they manage, while the Management_Teams table records the teams managing these portfolios, detailing their structure and roles. The Team_Asset_Management table links teams with specific assets they manage, including the strategies employed for asset management.

Reporting and Insights Tables: The Reports table stores periodic performance reports for portfolios, while the Insights table stores actionable insights derived from AI models, providing decision-makers with valuable information on market trends and investment performance.

### 1. Platform User Tables

### 1.1 Users Table

User_ID (Primary Key)
First_Name
Last_Name
Email
Password (encrypted)
Role (e.g., individual investor, family office manager, professional investor)
Registration_Date

### 1.2 User_Profile Table

Profile_ID (Primary Key)
User_ID (Foreign Key)
Contact_Details
Account_Type (e.g., mid-tier, ultra-rich)
Preferred_Investment_Strategies

### 2. Investment Management Tables

### 2.1 Investment_Portfolio Table

Portfolio_ID (Primary Key)
User_ID (Foreign Key)
Portfolio_Name
Portfolio_Type (public, private, mixed)
Managed_By (e.g., AI, human, hybrid)

### 2.2 Investment_Assets Table

Asser_ID (Primary Key)
Portfolio_ID (Foreign Key)
Asset_Type (e.g., equity, bond, real estate)
Asset_Details
Current_Value

### 3. AI Management Tables

### 3.1 AI_Models Table

Model_ID (Primary Key)
Model_Type (e.g., risk analysis, return optimization)
Model_Version
Last_Updated

### 3.2 AI_Analysis_History Table

Analysis_ID (Primary Key)
Model_ID (Foreign Key)
Portfolio_ID (Foreign Key)
Analysis_Date
Analysis_Result

### 4. Family Office and Professional Investor Managers Tables

### 4.1 Offices Table

Office_ID (Primary Key)
Office_Name
Office_Type (e.g., family office, professional investor manager)
Contact_Details

### 4.2 Office Portfolios Table

Office_Portfolio_ID (Primary Key)
Office_ID (Foreign Key)
Portfolio_ID (Foreign Key)

### 5. Management Teams Tables

### 5.1 Management_Teams Table

Team_ID (Primary Key)
Office_ID (Foreign Key)
Team_Details

### 5.2 Team_Asset_Management Table

Team_Asset_ID (Primary Key)
Team_ID (Foreign Key)
Asset_ID (Foreign Key)
Management_Strategies

### 6. Reporting and Insights Tables

### 6.1 Reports Table

Report_ID (Primary Key)
Portfolio_ID (Foreign Key)
Report_Type (e.g., monthly, quarterly)
Report_Date
Report_Details

### 6.2 Insights Table

Insight_ID (Primary Key)
Model_ID (Foreign Key)
Insight_Details
Insight_Date

### 2. Development and Platform Deployment Steps

Once the schema is finalized, the next steps involve developing and deploying the platform, ensuring smooth integration and performance.

Step 1: Choose a Diagram Tool

To begin the development process, a diagram tool like Lucid chart, Draw.io, or Microsoft Visio is selected to visualize the schema. This helps in understanding the data flow and interrelationships among various entities.

Step 2: Establish Main Entities

Entities such as Users, Investment_Portfolio, AI_Models, etc., are created as tables with the respective attributes (columns) outlined earlier. This establishes a clear data structure for the platform.

Step 3: Create Relationships

Relationships between entities are defined. For instance, the relationship between the User table and the User_Profile table is one-to-one, while the relationship between the Investment_Portfolio and Investment_Assets tables is one-to-many. These relationships are crucial for ensuring that the system functions efficiently and retrieves data as needed.

Step 4: Indicate Primary and Foreign Keys

Primary keys (PK) and foreign keys (FK) are marked in each entity to define how data is interrelated. For example, User_ID in the Investment_Portfolio table serves as a foreign key linking it to the Users table, ensuring data consistency and integrity.

Step 5: Integration with AI Models

The AI Models table is integrated with h relevant entities such as Investment_Portfolio and Investment_Assets. This allows the platform to apply AI-driven analysis to portfolios, providing personalized recommendations and insights to users.

Step 6: Add Auxiliary Features

Additional tables for auxiliary features like Reports and Insights are added, linking them to core tables such as Investment_Portfolio. These features are essential for generating performance reports and actionable insights for the users.

Step 7: Review and Optimize

The schema undergoes a review process to ensure that it meets normalization standards, eliminating redundant data and ensuring scalability. Any performance bottlenecks or inefficiencies are addressed during this phase.

Step 8: Annotations

Annotations or notes are added to the schema to clarify specific table structures, relationships, or attributes. This makes the schema easier to understand and facilitates communication among stakeholders.

Step 9: Finalize and Share

Once the schema is finalized, it is shared with relevant stakeholders for feedback. Changes are made based on the input received, and the final version of the schema is prepared for the development phase.

### 3. Deployment and Scaling

Once the schema design and development are complete, the platform is deployed. For scalability and flexibility, technologies like Kubernetes and containerization can be employed to manage application containers, ensuring that the platform can handle a growing number of users and high volumes of data. The deployment process involves integrating the database with the front-end application, ensuring that users can interact with their data securely and efficiently. Finally, the system is tested for performance, reliability, and security before being made available to end-users.

By following these steps, a robust, scalable, and secure database schema is created, and the computing unit is successfully developed and deployed to meet the needs of users, providing them with a powerful tool for managing and optimizing their investment strategies.

### INDUSTRIAL APPLICATIONS

The investment strategies management and recommendation system 100 for users has broad industrial applications, particularly in industries where personalized financial management and investment strategies are essential. In the financial services industry, the investment strategies management and recommendation system 100 revolutionizes how wealth management firms, investment companies, and brokerage houses deliver their services. By utilizing real-time data analysis and machine learning, these entities can offer highly personalized portfolio management solutions that align with individual client goals, risk tolerance, and current market conditions. For instance, wealth advisors can use the investment strategies management and recommendation system 100 to create bespoke investment strategies for clients, enhancing customer satisfaction and competitive advantage.

In the banking sector, the investment strategies management and recommendation system 100 can be seamlessly integrated into digital banking platforms, enabling banks to provide customers with personalized financial advice, investment recommendations, and portfolio monitoring tools. This not only improves user engagement but also allows banks to promote complementary financial products, such as mutual funds, insurance plans, and stock investments, effectively increasing revenue streams.

The investment strategies management and recommendation system 100 also benefits the insurance industry, where it supports the analysis of financial data and user profiles to recommend investment-linked insurance products. Additionally, the investment strategies management and recommendation system 100 helps in managing these products by continuously monitoring market trends and aligning them with customer objectives, ensuring optimal returns and user satisfaction.

For retail and online investment platforms, the investment strategies management and recommendation system 100 provides a strong solution to offer personalized, data-driven recommendations to individual investors. Platforms can utilize their capabilities to guide users through complex investment decisions, making them more accessible and actionable. By supporting features like portfolio tracking, collaborative tools, and secure data sharing, the investment strategies management and recommendation system 100 enhances the user experience and promotes informed decision-making across industries.

In yet another embodiment, the system provides personalized, real-time insights for investment strategies, assists users in financial planning through predictive analytics, facilitates trading and management of FIAT and or digital currencies. The system enables faster transactions and real-time data analysis compared to traditional methods and provides enhanced data security and ensures consistent regulatory compliance. The platform is designed for collaboration, inviting stakeholders, experts, and users to provide insights and feedback. The platform examines the individual investor, their unique needs and leverage technology to amplify human intelligence.

As already disclosed, the system may, in form of a collaborative platform, may provide real-time insights directly to users' mobile phones, leveraging contextual data and on-edge AI as needed and available to provide timely and relevant advice. Further, in such embodiments, the system may include adaptive data governance and compliance module ensures that the platform is always aligned with the latest regulatory requirements, maintaining high standards of data security and privacy. Additionally, the system in such embodiments, may integrate adaptive data ontology to enable the analysis of a wider range of data sources and delivering more comprehensive insights. The integrated platform helps user understand complex investment strategies and make more informed decisions. The platform's modular architecture allows to adapt and scale according to changing market dynamics and user needs. The collaborative platform endorses family offices, professional investor managers, and individual users to interact and collaborate more effectively.

Further in such embodiments, a blockchain technology may be integrated with the platform to ensure compliance with financial regulations as all transactions are recorded and may be audited with ease. The blockchain technology facilitate hyper-fast transactions, allowing for quicker trades and settlements compared to traditional methods. The integration of exchange platform with system platform provides users a wide array of investment opportunities of currency conversion. The system may monitor real-time market dynamics, providing users with up-to-the-moment data that may help in making informed investment decisions. The platform may be designed to integrate easily with future cryptocurrencies and digital assets, ensuring it remains relevant in the changing financial landscape. The integration of AI technology with platform may utilize AI for portfolio management and automatically manage many processes, making the investment management more efficient and reducing costs. The platform may facilitate the creation of innovative financial products, potentially unlocking new investment opportunities and revenue streams.

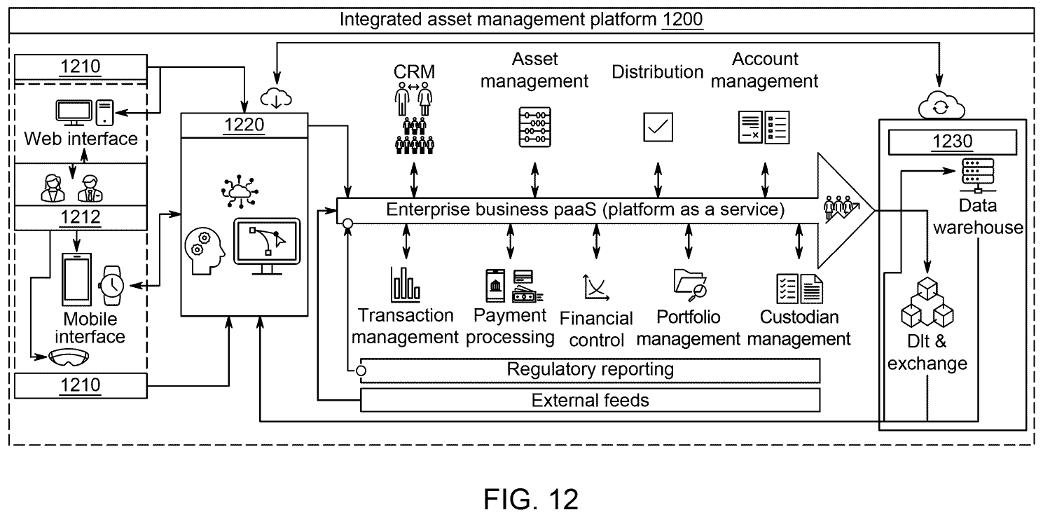

FIG. 12 illustrates an exemplary implementation of the system of the current disclosure, wherein the system includes a platform 1200 adapted to deliver asset management to a plurality of first users 1210 through the computing unit 1212. As illustrated, the computing unit 1212 may be in form of one or more of a mobile phone having app interface, a computer having a web interface, a VR device having a meta interface or a smart watch. Additionally, the computing unit 1212 may be any suitable device as known in the art, without deviating from the scope of the current disclosure. Further, the platform 1200 includes a backend server 1220 comprising a plurality of modules [not shown] for processing the information received from the plurality of users, and their respective contextual information to provide them with a plurality of services such as transaction management, payment processing, financial planning, portfolio management, custodian management, account management, asset management, distribution management, stock related services and the like. The platform 1200 in such embodiments further includes a data ware house 1230 for storage of plurality of user's data, details of assets, and any other storage requirement. The data-ware house 1230 may be connected to a ledger of a service provider, which in turn provides output through one or more output means of the computing units 1212.

The embodiments herein and the various features and advantageous details are explained concerning the non-limiting embodiments in the following description. Descriptions of well-known components and processing techniques are omitted to not unnecessarily obscure the embodiments herein. The examples used herein are intended merely to facilitate an understanding of how the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles, or the like that has been included in this specification is solely to provide a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions, or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A system for managing financial portfolio and recommending personalized investment strategies to a user, the system comprising:
a computing unit comprising an application interface adapted to access and interact with user data;
a central controller comprising a backend server communicably connected to the application interface of the computing unit, the backend server comprising:
a data receiving component adapted to receive real-time input data from a plurality of data sources, the real-time input data pertaining to the market, assets, stocks, and various financial information;
a data analysis module adapted to normalize and process the received input data to generate actionable insights;
a contextually intelligent portfolio management module adapted to continuously monitor user's investments and asset portfolios and generate contextually relevant portfolio information in real-time;
a financial strategy implementation module adapted to utilize the generated actionable insights in combination with the contextually relevant portfolio information to create personalized investment strategies and recommendations;
characterized in that the central controller is configured to automatically manage, monitor & recommend/visualize personalized investment strategies onto the application interface of the computing unit.

2. The system of claim 1 further comprises a data exchange platform communicably connected to the central controller and adapted to be accessed by a plurality of users, enabling real-time collaboration related to managing an investment and asset portfolio.

3. The system of claim 1, wherein the user data includes, but is not limited to, user profile data, investment history, behavioral data, preferences, and user's contextual data.

4. The system of claim 1, wherein the real-time input data include, but is not limited to, market data, assets data, stock data, user contextual data, and various financial information.

5. The system of claim 1, wherein the plurality of data-sources includes, but is not limited to, user profiles, stock exchange databases, contextual information servers, financial data providers, and websites.

6. The system of claim 1, wherein the data receiving component continuously monitors and updates market fluctuations in real-time and synchronizes input data from the geographically distributed plurality of data-sources to provide a global perspective on financial trends.

7. The system of claim 1, wherein the data analysis module further comprises:
a trend analysis sub-module adapted to identify patterns and correlations in the received data to predict market behaviors.

8. The system of claim 1, wherein the data analysis module utilizes machine learning techniques to predict potential market shifts by analyzing historical patterns and current trends in real-time input data and refining insights.

9. The system of claim 1, wherein the contextually intelligent portfolio management module comprises:
a monitoring sub-module adapted to track portfolio performance against market trends and predefined user goals;
an alert generation sub-module adapted to provide users with real-time notifications on critical market changes or opportunities.

10. The system of claim 1, wherein the financial strategy implementation module comprises:
a strategy generation sub-module adapted to create personalized investment strategies based on user preferences and actionable insights;
a feedback sub-module adapted to refine investment strategies by analyzing the outcomes of past recommendations and user interactions.

11. The system of claim 1, wherein the financial strategy implementation module utilizes machine learning algorithms for continuously improving the quality of actionable insights and recommendations.

12. The system of claim 1, wherein the data exchange platform further comprises:
a collaboration sub-module adapted to facilitate secure communication and real-time sharing of investment insights among users;
a privacy management sub-module adapted to enforce data-sharing permissions and ensure compliance with financial privacy regulations.

13. The system of claim 1, wherein the application interface of the computing unit displays user-specific portfolio analytics, market updates, and actionable alerts

14. The system of claim 1, wherein the users are allowed to independently access personalized investment strategies while ensuring data segregation and security.

15. A method for managing and recommending personalized investment strategies to a user, the method comprising:
accessing and interacting with user data using a computing unit comprising an application interface;
establishing a communicable connection between the application interface of the computing unit and a backend server for:
receiving real-time input data from a plurality of data sources, the real-time input data pertaining to the market, assets, stocks, and various financial information;
normalizing and processing the received input data to generate actionable insights;
continuously monitoring user's investments and asset portfolios and generating contextually relevant portfolio information in real-time;
utilizing the generated actionable insights in combination with the contextually relevant portfolio information for creating personalized investment strategies and recommendations;
characterized in that automatically managing, monitoring & recommending/visualizing personalized investment strategies onto the application interface of the computing unit.

16. The method of claim 15, wherein the real-time input data include, but is not limited to, market data, assets data, stock data, user contextual data, and various financial information.

17. The method of claim 15, wherein normalizing and processing the received input data further comprises:
removing duplicate or inconsistent data entries to ensure data integrity;
categorizing input data based on predefined criteria, including, but not limited to, such as asset classes, geographic regions, and market sectors.

18. The method of claim 15, wherein generating the actionable insights includes:
identifying investment opportunities based on real-time input data;
predicting potential market shifts using machine learning algorithms trained on past data;

19. The method of claim 15 utilizes user feedback to refine investment strategies by analyzing the outcomes of past recommendations and user interactions.

20. The method of claim 15, wherein continuously monitoring user investments and asset portfolios further comprises:
tracking portfolio value changes in response to real-time market fluctuations;
generating alerts for deviations from user-defined risk thresholds or performance targets.
